(19) United States
(12) Patent Application Publication
(10) Pub. No.: US 2026/0145598 A1
(43) Pub. Date: May 28, 2026

(54) RECONFIGURABLE SEATS FOR RECREATIONAL VEHICLE

(71) Applicant: Textron Inc., Providence, RI (US)

(72) Inventors: Ricky Veldee Kemp, Augusta, GA (US); Jay Richardson, North Augusta, SC (US); Charles Daniel Dauchess, North Augusta, SC (US)

(73) Assignee: Textron Inc., Providence, RI (US)

(21) Appl. No.: 18/956,366

(22) Filed: Nov. 22, 2024

(51) Int. Cl. B60N 2/30; B60N 2/36; B62D 25/06

(52) U.S. Cl. CPC B60N 2/305; B60N 2/3036; B62D 25/06; B60N 2002/363

(57) ABSTRACT

A golf vehicle includes a chassis, a body coupled to the chassis, and a seat assembly. The seat assembly is movable between a seat configuration and a storage configuration. The seat assembly includes a seat base coupled to the at least one of the chassis or the body and a bottom cushion assembly movably coupled to the seat base. The bottom cushion assembly is in a first position above the seat base when the seat assembly is in the seat configuration and is in a second position forward of the seat base when the seat assembly is in the storage configuration.

### BACKGROUND

A recreational vehicle may include an occupant seating area including rows of seat assemblies. However, such seat assemblies may limit a storage volume of the recreational vehicle. The present application relates to seat assemblies that are reconfigurable between seat configurations configured to support occupants and storage configurations configured to define a storage bed of the recreational vehicle such that an operator of the recreational vehicle may place the seat assemblies in the seat configurations to increase an occupant capacity of the recreational vehicle or place the seat assemblies in the storage configurations to increase a storage capacity of the recreational vehicle.

### SUMMARY

One embodiment relates to a golf vehicle. The golf vehicle includes a chassis, a body coupled to the chassis, and a seat assembly movable between a seat configuration and a storage configuration. The seat assembly includes a seat base coupled to the at least one of the chassis or the body and a bottom cushion assembly movably coupled to the seat base. The bottom cushion assembly is in a first position above the seat base when the seat assembly is in the seat configuration and is in a second position forward of the seat base when the seat assembly is in the storage configuration.

Another embodiment relates to a recreational vehicle. The recreational vehicle includes a chassis, a body coupled to the chassis, a first seat assembly coupled to at least one of the chassis or the body, and a second seat assembly coupled to at least one of the chassis or the body. The first seat assembly is movable between a first seat configuration and a first storage configuration where the first seat assembly defines a first portion of a storage bed of the recreational vehicle. The second seat assembly is movable between a second seat configuration and a second storage configuration where the second seat assembly defines a second portion of the storage bed.

Still another embodiment relates to a seat assembly for a recreational vehicle. The seat assembly includes a seat base configured to couple to at least one of a chassis or a body of the recreational vehicle, a bottom cushion assembly pivotably coupled to the seat base, and a back cushion assembly at least one of removably or pivotably coupled to the seat base, The seat base defines a first surface. The bottom cushion assembly defines a second surface on a first side of the bottom cushion assembly. The bottom cushion assembly is pivotable between a first position where the second surface is supported by the first surface and a second position where the second surface aligns with the first surface. The back cushion assembly is in a third position above the seat base when the seat assembly is in the third configuration and is in a fourth position below the first surface of the seat base when the seat assembly is in the storage configuration.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a front perspective view of the vehicle of FIG. 1 with a rear seat assembly in a seat configuration, according to an exemplary embodiment.

FIG. 4 is a side perspective view of the vehicle of FIG. 1 with the rear seat assembly in a storage configuration, according to an exemplary embodiment.

FIG. 5 is a side perspective view of the vehicle of FIG. 1 with the rear seat assembly in the storage configuration and a passenger seat assembly in a storage configuration, according to an exemplary embodiment.

FIG. 6 is a perspective view of a vehicle with a rear seat assembly in a seat configuration and a middle seat assembly in a seat configuration, according to an exemplary embodiment.

FIG. 7 is a perspective view of the vehicle of FIG. 6 with the rear seat assembly in a storage configuration and the middle seat assembly in a seat configuration, according to an exemplary embodiment.

FIG. 8 is a perspective view of the vehicle of FIG. 6 with the rear seat assembly and the middle seat assembly in a storage configuration, according to an exemplary embodiment.

FIG. 9 is a perspective view of a vehicle with a rear seat assembly and the middle seat assembly in a storage configuration, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

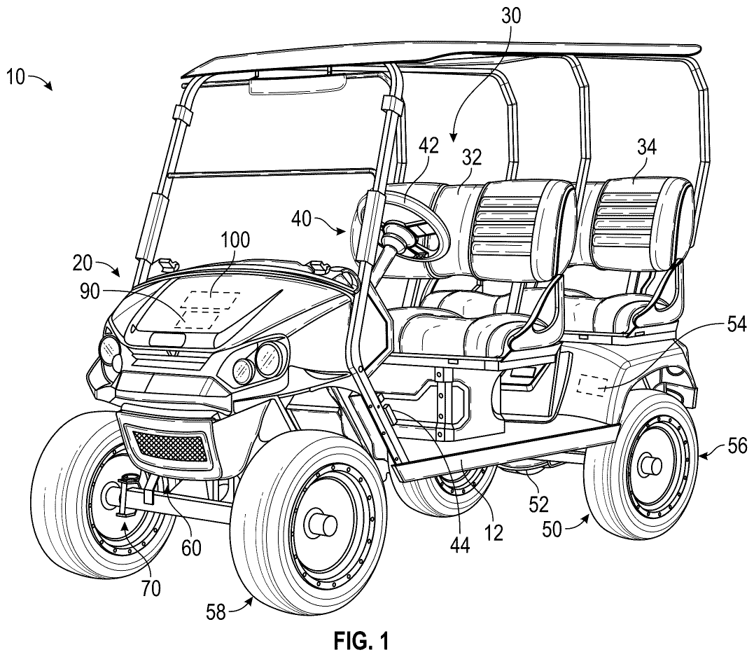

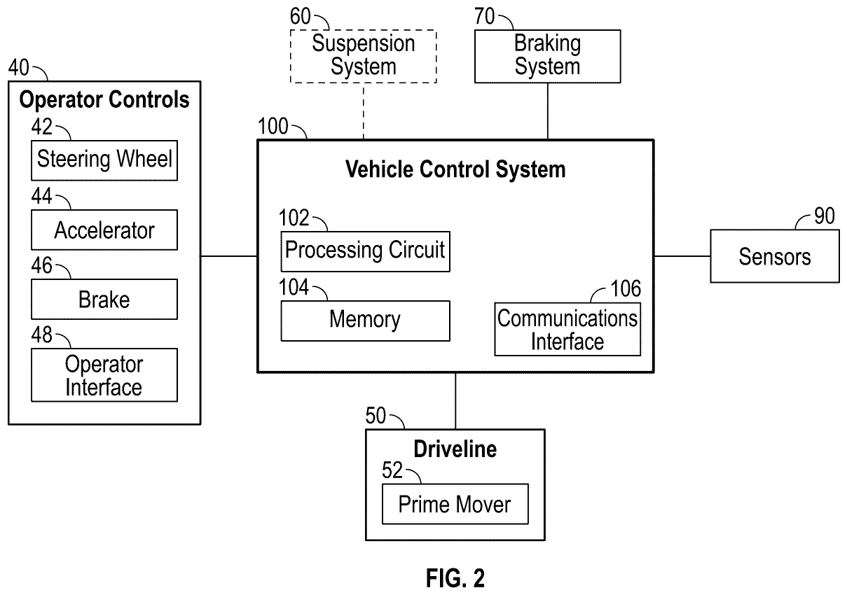

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or golf vehicle, an all-terrain vehicle (“ATV”), a utility task vehicle (“UTV”), a low speed vehicle (“LSV”), a personal transport vehicle (“PTV”), and/or another type of lightweight or recreational machine or recreational vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

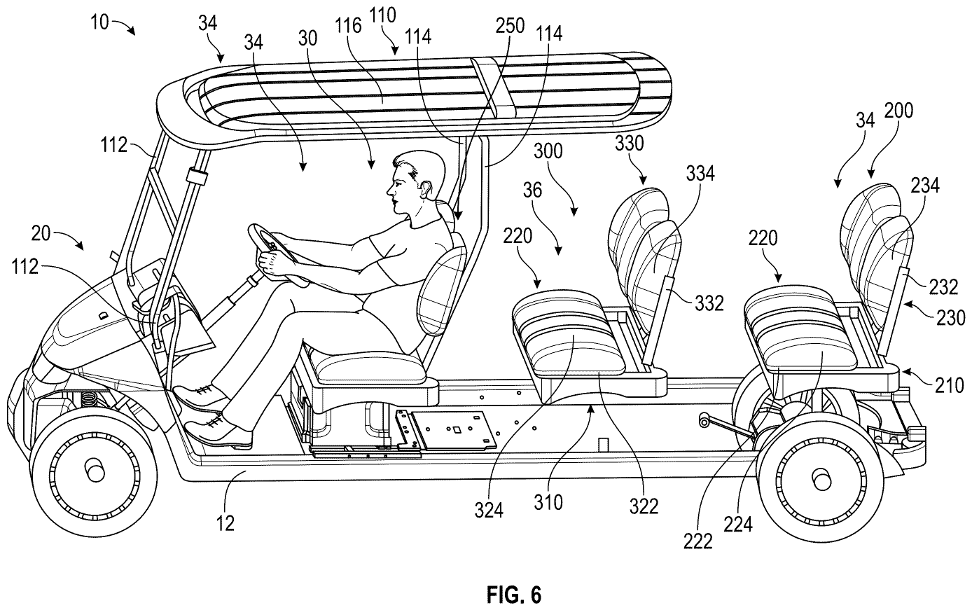

According to the exemplary embodiment shown in FIG. 1, the occupant seating area 30 includes a plurality of rows of seating including a first row of seating, shown as front row seating 32, and a second row of seating, shown as rear row seating 34. According to the exemplary embodiment shown in FIGS. 6-9, the occupant seating area 30 includes the third row of seating, shown as middle row seating 36, positioned between the front row seating 32 and the rear row seating 34. In some embodiments, the occupant seating area 30 includes a plurality of the middle row seatings 36 positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

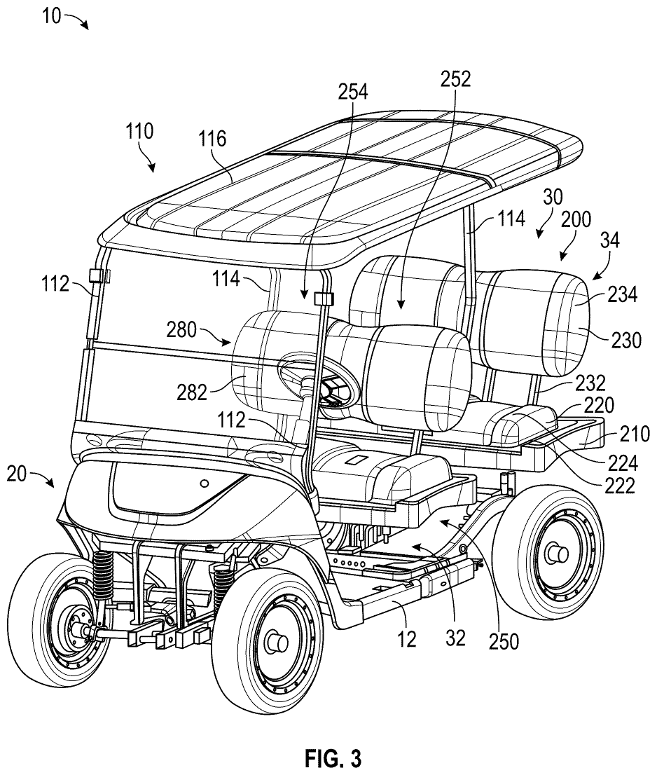

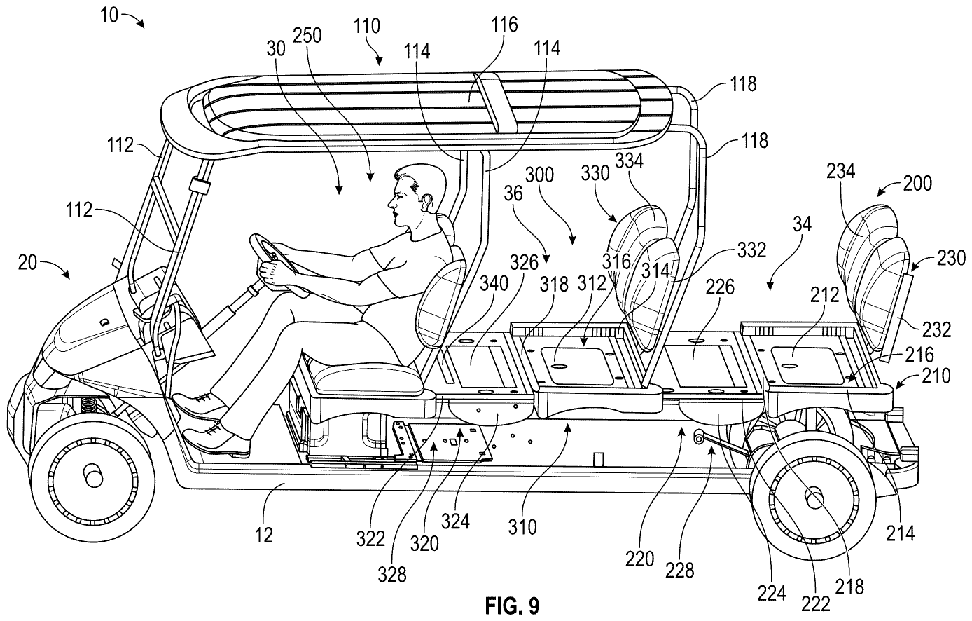

As shown in FIGS. 3-9, the body 20 includes a canopy assembly, shown as canopy assembly 110, positioned over at least a portion of the occupant seating area 30. As shown in FIGS. 3-9, the canopy assembly 110 includes first pillars, shown as a-pillars 112, second pillars, shown as b-pillars 114, positioned rearward of the a-pillars 112, and a canopy, shown as canopy 116, coupled to the a-pillars 112 and the b-pillars 114 and positioned over the portion of the occupant seating area 30. According to the exemplary embodiment shown in FIG. 9, the canopy assembly 110 includes third pillars, shown as c-pillars 118, coupled to the canopy 116. The c-pillars 118 are positioned rearward of the a-pillars 112 and the b-pillars 114.

### Stowable Seat Assemblies

As shown in FIGS. 3-9, the rear row seating 34 includes a first seat assembly (e.g., first flipping seat assembly, first stowable seat assembly, a rear seat assembly, etc.), shown as rear row seat assembly 200, coupled to at least one of the chassis 12 or the body 20. In some embodiments, the rear row seat assembly 200 is coupled to the canopy assembly 110 (e.g., the b-pillars 114, the c-pillars 118, etc.). According to the exemplary embodiment shown in FIGS. 3-9, the rear row seat assembly 200 is forward facing. In other embodiments, the rear row seat assembly 200 is rearward facing. The rear row seat assembly 200 includes a first base, shown as rear row seat base 210, coupled to at least one of the fame 12 or the body 20; a first bottom cushion assembly, shown as rear row bottom cushion assembly 220, configured to support a bottom (e.g., a buttocks, etc.) of an occupant (e.g., when the occupant is occupying the rear row seat assembly 200, etc.); and a first back cushion assembly, shown as rear row back cushion assembly 230, configured to support a back (e.g., a dorsum, etc.) of the occupant.

The rear row seat assembly 200 is selectively reconfigurable (e.g., configurable, movable, adjustable, etc.) between a rear row seat configuration where the rear row seat assembly 200 is configured to support an occupant and a rear row storage configuration where the rear row seat assembly 200 defines a rear portion of a storage bed (e.g., a storage platform, etc.) of the vehicle 10. The storage bed of the vehicle 10 may receive objects (e.g., golf bags, golf equipment, bags, tools, etc.) for storage and transport with the vehicle 10. By way of example, an occupant capacity of the vehicle 10 may be higher when the rear row seat assembly 200 is in the rear row seat configuration than when the rear row seat assembly 200 is in the rear row storage configuration. By way of another example, a storage capacity of the vehicle 10 may be higher when the rear row seat assembly 200 is in the rear row storage configuration than when the rear row seat assembly 200 is in the rear row seat configuration.

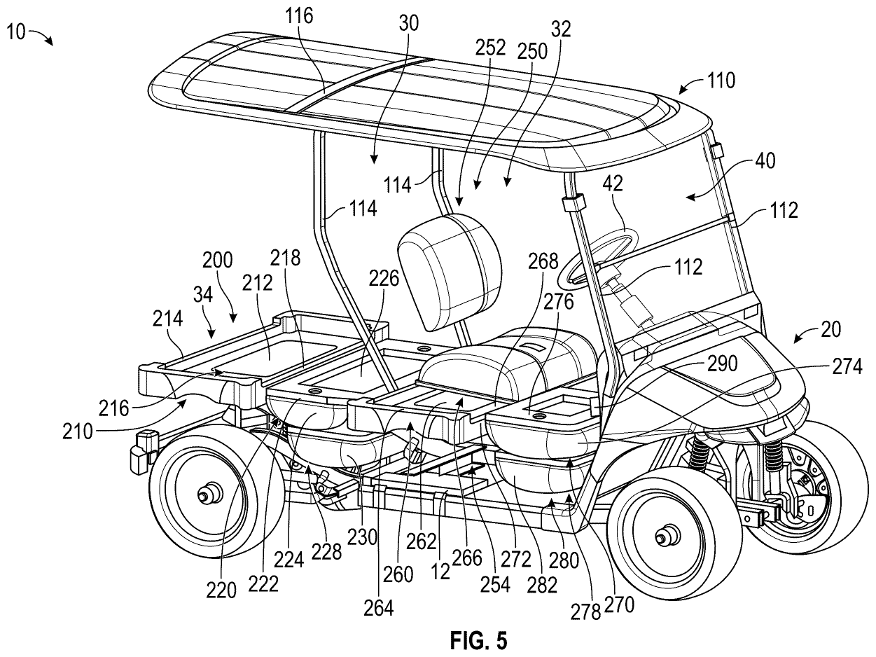

As shown in FIGS. 3 and 6, the rear row seat assembly 200 can be placed in the rear row seat configuration with the rear row bottom cushion assembly 220 positioned above the rear row seat base 210 and the rear row back cushion assembly 230 oriented in a substantially vertical orientation relative to the rear row bottom cushion assembly 220. As shown in FIGS. 5, 7, and 8, the rear row seat assembly 200 can be placed in the rear row storage configuration with an upper surface of the rear row bottom cushion assembly 220 positioned substantially even with an upper surface of the rear row seat base 210 to form the rear portion of the storage bed of the vehicle 10 and the rear row back cushion assembly 230 is positioned below the upper surfaces of the rear row bottom cushion assembly 220 and the rear row seat base 210. In some embodiments, the rear row bottom cushion assembly 220 may rest on the front seating row 32 and/or the middle seating row 34 when the rear row seat assembly 200 is in the rear row storage configuration. In other embodiments, the rear row bottom cushion assembly 220 may rest on at least one of the body 20 or the frame 12 when the rear row seat assembly 200 is in the rear row storage configuration. In some embodiments, a first portion of the rear row seat assembly 200 can be placed in the rear row storage configuration and/or the rear row seat configuration separately (e.g., independently, etc.) from a second portion of the rear row seat assembly 200. By way of example, a left side portion of the rear row seat assembly 200 may be independently operated between the rear row storage configuration and the rear row seat configuration from a right side portion of the rear row seat assembly 200. In some embodiments, the rear row seat assembly 200 are removably coupled to at least one of the frame 12 or the body 20 and may be removed from the vehicle 10 to increase a storage volume of the vehicle 10.

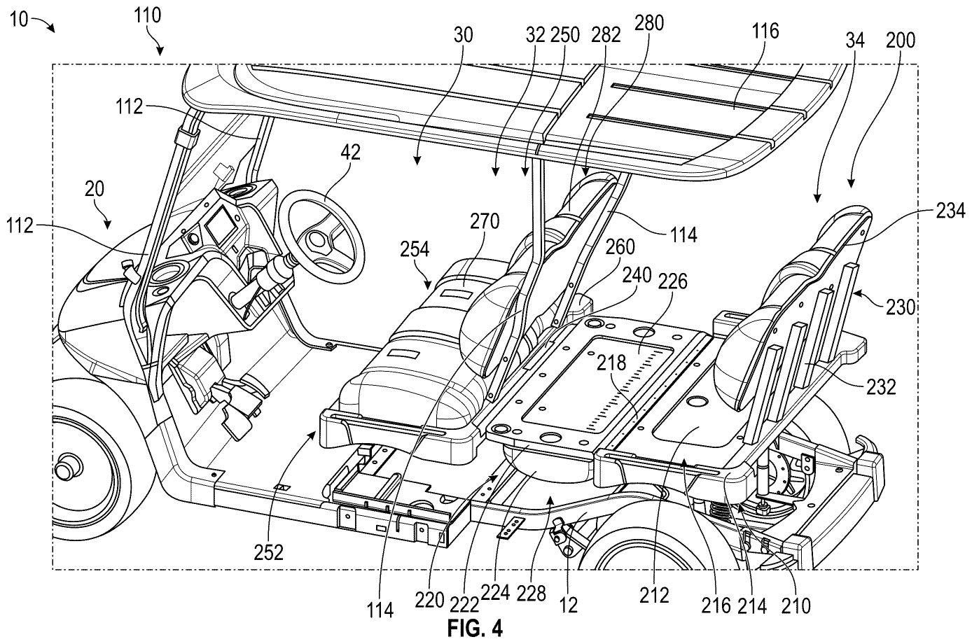

As shown in FIGS. 4, 5, and 7-9, the rear row seat base 210 includes a first upper surface, shown as rear base storage surface 212, extending at least partially along the rear row seat base 210 and a first upper lip, shown as rear base lip 214, extending around at least a portion of a perimeter of the rear base storage surface 212. The rear base storage surface 212 may support the rear row bottom cushion assembly 220 when the rear row seat assembly 200 is in the rear row seat configuration and define a first portion of the rear portion of the storage bed of the vehicle 10 when the rear row seat assembly 200 is in the rear row storage configuration. By way of example, the rear base storage surface 212 may be a substantially flat surface that may either support the rear row bottom cushion assembly 220 or define the first portion of the rear portion of the storage bed of the vehicle 10. As shown in FIGS. 4, 5, and 7-9, the rear base lip 214 and the rear base storage surface 212 collectively define a first cavity, shown as rear seat cavity 216. The rear seat cavity 216 may receive at least a portion of the rear row bottom cushion assembly 220 when the rear row seat assembly 200 is in the rear row seat configuration. By way of example, the rear seat cavity 216 may receive the portion of the rear row bottom cushion assembly 220 when the rear row seat assembly 200 is in the rear row seat configuration to prevent lateral movement of the rear row bottom cushion assembly 220 relative to the rear row seat base 210.

As shown in FIGS. 3-9, the rear row bottom cushion assembly 220 includes a first bottom cushion base, shown as rear row bottom cushion base 222, and a first bottom cushion, shown as rear row bottom cushion 224, coupled to the rear row bottom cushion base 222. As shown in FIGS. 4, 5, and 7-9, the rear row bottom cushion base 222 includes a first support surface, shown as rear row base surface 226, on a first side of the rear row bottom cushion base 222. The rear row bottom cushion 224 may be coupled to an opposing second side of the rear row bottom cushion base 222 (e.g., opposing the rear row base surface 226, etc.). When the rear row seat assembly 200 is in the rear row seat configuration, the rear row base surface 226 may contact the rear base storage surface 212 to support the rear row bottom cushion assembly 220 on the rear row seat base 210. When the rear row seat assembly 200 is in the rear row storage configuration, the rear row base surface 226 may define a second portion of the rear portion of the storage bed of the vehicle 10. By way of example, when the rear row seat assembly 200 is in the rear row storage configuration, the rear row base surface 226 may align (e.g., be coincident with, be substantially even with, be oriented at a same angle as, etc.) with the rear base storage surface 212 to form the rear portion of the storage bed of the vehicle 10.

As shown in FIGS. 3, 4, and 6-9, the rear row back cushion assembly 230 includes a first back cushion frame, shown as rear row back cushion frame 232, coupled to the rear row seat base 210, and a first back cushion, shown as rear row back cushion 234, coupled to the rear row back cushion frame 232. According to the exemplary embodiment shown in FIGS. 3, 4, and 6-9, the rear row back cushion frame 232 is configured to releasably couple to the rear row seat base 210. By way of example, the rear row back cushion frame 232 may include a plurality of rear row back cushion legs that may be selectively received within apertures defined by the rear row seat base 210 to releasably couple the rear row back cushion assembly 230 to the rear row seat base 210. When the rear row seat assembly 200 is in the rear row seat configuration, the rear row back cushion assembly 230 may be releasably coupled to the rear row seat base 210. When the rear row seat assembly 200 is in the rear row storage configuration, the rear row back cushion assembly 230 may be detached from the rear row seat base 210 and stowed elsewhere on the vehicle 10 and/or stowed external to the vehicle 10. In other embodiments, the rear row back cushion assembly 230 is configured to releasably couple to the rear row bottom cushion assembly 220 and/or to at least one of the body 20 or the frame 12.

As shown in FIGS. 3-9, the rear row bottom cushion base 222 of the rear row bottom cushion assembly 220 is pivotably coupled to a first forward edge of the rear row seat base 210, shown as rear row pivot edge 218. The rear row bottom cushion assembly 220 may pivot about the rear row pivot edge 218 between a rear row seat position (e.g., a first position, etc.) to place the rear row seat assembly 200 in the rear row seat configuration and a rear row storage position (e.g., a second position, etc.) to place the rear row seat assembly 200 in the rear row storage configuration. By way of example, the rear row bottom cushion assembly 220 may pivot forward about the rear row pivot edge 218 from the rear row seat position towards the rear row storage position. By way of another example, the rear row bottom cushion assembly 220 may pivot rearward about the rear row pivot edge 218 from the rear row storage position toward the rear row seat position. In other embodiments, the rear row bottom cushion base 222 of the rear row bottom cushion assembly 220 is pivotably coupled to a first rear edge of the rear row seat base 210 and may pivot about the first rear edge of the rear row seat base 210 between the rear row seat position and the rear row storage position. By way of example, the rear row bottom cushion assembly 220 may pivot rearward about the first rear edge of the rear row seat base 210 from the rear row seat position toward the rear row storage position and/or forward about the first rear edge of the rear row seat base 210 from the rear row storage position toward the rear row seat position. In still other embodiments, the rear row bottom cushion assembly 220 may otherwise move relative to the rear row seat base 210 to move between the rear row seat position and the rear row storage position (e.g., slide, translate, etc.).

As shown in FIGS. 4, 5, and 7-9, when the rear row bottom cushion assembly 220 is in the rear row storage position, the rear row bottom cushion assembly 220 and at least one of the frame 12 or the body 20 defines a rear row storage opening 228. By way of example, the rear row storage opening 228 may include a rear row footwell where an occupant of the rear row seat assembly 200 may place their feet while occupying the rear row seat assembly 200. By way of another example, the rear row storage opening 228 may be positioned between the rear row bottom cushion 224 and the at least one of the frame 12 or the body 20 when the rear row seat assembly 200 is in the rear row storage configuration. According to the exemplary embodiment shown in FIG. 5, when the rear row seat assembly 200 is in the rear row storage configuration, the rear row back cushion assembly 230 may be positioned (e.g., stowed, etc.) within the rear row storage opening 228 such that the rear row back cushion assembly 230 is positioned below the rear base storage surface 212 and/or the rear row base surface 226. As a result, the rear row back cushion assembly 230 may not be positioned within a rear storage area positioned above the rear portion of the storage bed of the vehicle 10 when the rear row seat assembly 200 is in the rear row storage configuration.

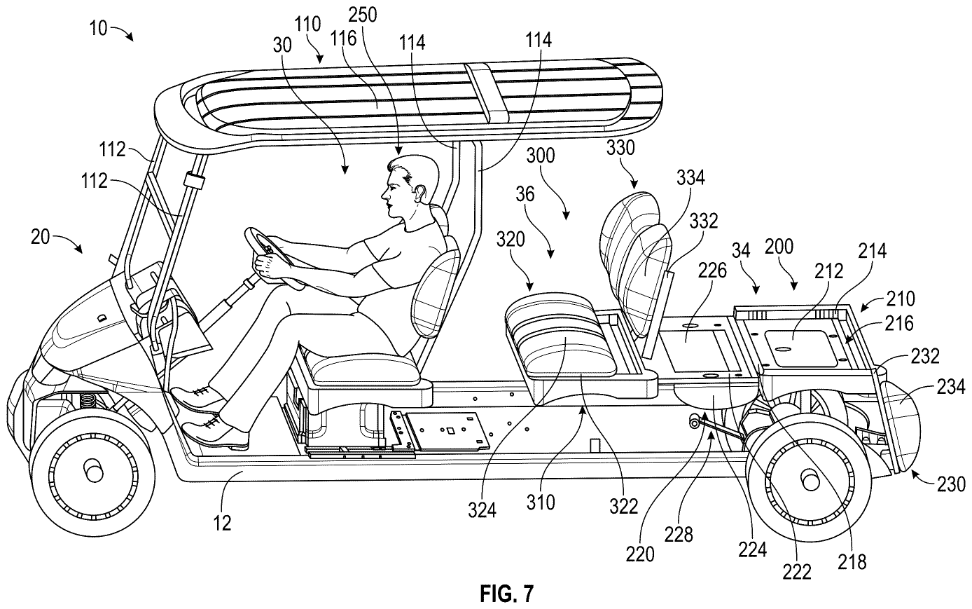

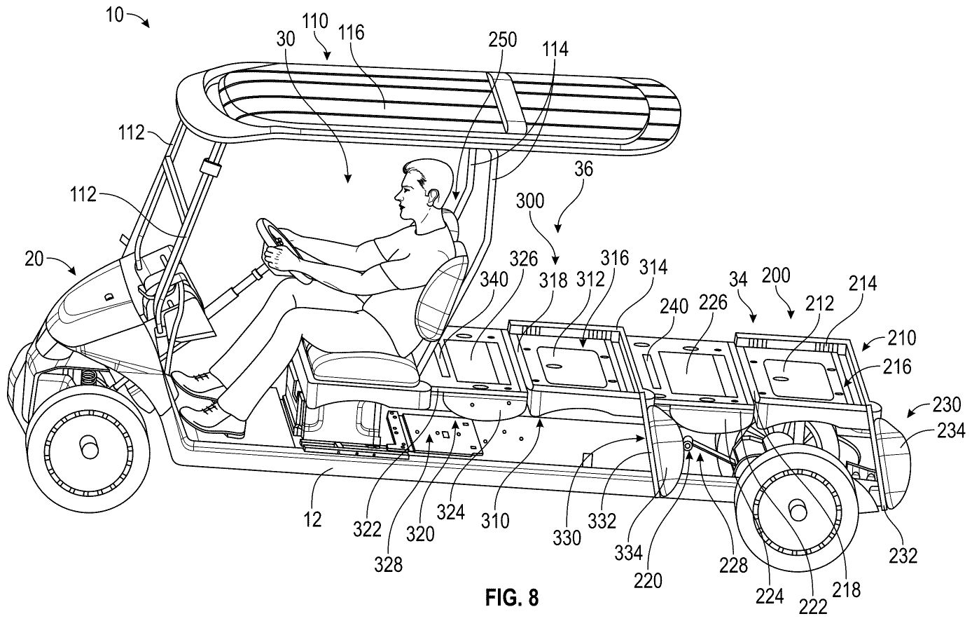

According to the exemplary embodiment shown in FIGS. 7 and 8, the rear row back cushion frame 232 of the rear row back cushion assembly 230 is pivotably coupled to the rear row seat base 210. The rear row back cushion assembly 230 may pivot relative to the rear row seat base 210 to place the rear row seat assembly 200 in the rear row storage configuration or the rear row seat configuration. By way of example, the rear row back cushion assembly 230 may pivot rearward relative to the rear row seat base 210 such that the rear row back cushion assembly 230 pivots below the rear base storage surface 212 and/or the rear row base surface 226 to place the rear row seat assembly 200 in the rear row storage configuration. By way of another example, the rear row back cushion assembly 230 may pivot forward relative to the rear row seat base 210 such that the rear row back cushion assembly 230 extends above the rear base storage surface 212 and/or the rear row base surface 226 to place the rear row seat assembly 200 in the rear row seat configuration.

As shown in FIGS. 4 and 8, the rear row seat assembly 200 includes a first interface assembly, shown as rear row interface assembly 240, configured to secure the rear row bottom cushion assembly 220 in the rear row seat position and/or the rear row storage position. The rear row interface assembly 240 may selectively prevent the rear row bottom cushion assembly 220 from pivoting relative to the rear row seat base 210. By way of example, the rear row interface assembly 240 may be coupled to the rear row bottom cushion assembly 220 and configured to interface with the rear row seat base 210 when the rear row bottom cushion assembly 220 is in the rear row seat position to selectively prevent the rear row bottom cushion assembly 220 from pivoting relative to the rear row seat base 210 such that the rear row seat assembly 200 is prevented from leaving the rear row seat configuration. By way of another example, the rear row interface assembly 240 may be coupled to the rear row bottom cushion assembly 220 and configured to interface with the front row seating 32 or the middle row seating 36 when the rear row bottom cushion assembly 220 is in the rear row storage position to selectively prevent the rear row bottom cushion assembly 220 from pivoting relative to the rear row seat base 210 such that the rear row seat assembly 200 is prevented from leaving the rear row storage configuration. The rear row interface assembly 240 may be configured as a latch assembly configured to interface with a corresponding latch assembly of the rear row seat base 210 and/or the front row seating 32 or the middle row seating 36, hook or look fastener portions configured to interface with hook and loop fastener portions of the rear row seat base 210 and/or the front row seating 32 or the middle row seating 36, or any other means configured to selectively prevent the rear row bottom cushion assembly 220 from pivoting relative to the rear row seat base 210. In some embodiments, the rear row interface assembly 240 may be operated (e.g., by an occupant of the vehicle 10, etc.) to allow the rear row bottom cushion assembly 220 to pivot relative to the rear row seat base 210.

As shown in FIGS. 3-9, the front row seating 32 includes a second seat assembly (e.g., a second flipping seat assembly, a stowable seat assembly, a front seat assembly, etc.), shown as front row seat assembly 250, coupled to at least one of the chassis 12 or the body 20. In some embodiments, the front row seat assembly 250 is coupled to the canopy assembly 110 (e.g., the b-pillars 114, etc.). As shown in FIGS. 3-5, the front row seat assembly 250 includes a first portion, shown as driver seat portion 252, configured to support an operator of the vehicle 10, and a second portion, shown as passenger seat portion 254, configured to support a passenger of the vehicle 10. By way of example, the driver seat portion 252 may be positioned on a first side of the front row seat assembly 250 and the passenger seat portion 254 may be positioned on an opposing second side of the front row seat assembly 250. By way of another example, the driver seat portion 252 may be a portion of the front row seat assembly 250 positioned behind the steering wheel 42 and the passenger seat portion 254 may be a remainder of the front row seat assembly 250 not positioned behind the steering wheel 42. The passenger seat portion 254 includes a second base, shown as passenger seat base 260, coupled to at least one of the frame 12 or the body 20, a second bottom cushion assembly, shown as passenger bottom cushion assembly 270, configured to support a bottom of an occupant (e.g., when the occupant is occupying the front row seat assembly 250, etc.); and a second back cushion assembly, shown as passenger back cushion assembly 280, configured to support a back of the occupant.

According to an exemplary embodiment, the passenger seat portion 254 of the front row seat assembly 250 is reconfigurable between a passenger seat configuration where the passenger seat portion 254 is configured to support an occupant and a passenger storage configuration where the passenger seat portion 254 defines a front portion of the storage bed of the vehicle 10. By way of example, the occupant capacity of the vehicle 10 may be higher when the front row seat assembly 250 is in the passenger seat configuration than when the front row seat assembly 250 is in the passenger storage configuration. By way of another example, the storage capacity of the vehicle 10 may be higher when the front row seat assembly 250 is in the passenger storage configuration than when the front row seat assembly 250 is in the passenger seat configuration. When the rear row seat assembly 200 is in the rear row storage configuration and the front row seat assembly 250 is in the passenger storage configuration, the vehicle 10 may receive objects that are longer than the objects that the vehicle 10 may receive when only the rear row seat assembly 200 is in the rear row storage configuration. By way of example, when the rear row seat assembly 200 is in the rear row storage configuration and the front row seat assembly 250 is in the passenger storage configuration, the vehicle 10 may receive a stretcher supported by the rear row seat assembly 200 and the front row seat assembly 250.

As shown in FIGS. 3 and 4, the passenger seat portion 254 can be placed in the passenger seat configuration with the passenger bottom cushion assembly 270 positioned above the passenger seat base 260 and the passenger back cushion assembly 280 oriented in a substantially vertical orientation relative to the passenger bottom cushion assembly 270. As shown in FIG. 5, the passenger seat portion 254 can be placed in the passenger storage configuration with an upper surface of the passenger bottom cushion assembly 270 positioned substantially even with an upper surface of the passenger seat base 260 to form the front portion of the storage bed of the vehicle 10 and the passenger back cushion assembly 280 is positioned below the upper surfaces of the passenger seat base 260 and the passenger bottom cushion assembly 270. In some embodiments, the passenger bottom cushion assembly 270 may rest on at least one of the body 20 or the frame 12 when the front row seat assembly 250 is in the passenger storage configuration.

As shown in FIG. 5, the passenger seat base 260 includes a second upper surface, shown as passenger base storage surface 262, extending at least partially along the passenger seat base 260 and a second upper lip, shown as passenger base upper lip 264, extending around at least a portion of a perimeter of the passenger base storage surface 262. The passenger base storage surface 262 may support the passenger bottom cushion assembly 270 when the passenger seat portion 254 is in the passenger seat configuration and define a first portion of the front portion of the storage bed of the vehicle 10 when the passenger seat portion 254 is in the passenger storage configuration. By way of example, the passenger base storage surface 262 may be a substantially flat surface that may either support the passenger bottom cushion assembly 270 or define the first portion of the front portion of the storage bed of the vehicle 10. As shown in FIG. 5, the passenger base upper lip 264 and the passenger base storage surface 262 collectively define a second cavity, shown as passenger seat cavity 266. The passenger seat cavity 266 may receive at least a portion of the passenger bottom cushion assembly 270 when the passenger seat portion 254 is in the passenger seat configuration. By way of example, the passenger seat cavity 266 may receive the portion of the passenger bottom cushion assembly 270 when the passenger seat portion 254 is in the passenger seat configuration to prevent lateral movement of the passenger bottom cushion assembly 270 relative to the passenger seat base 260.

As shown in FIG. 5, the passenger bottom cushion assembly 270 includes a second bottom cushion base, shown as passenger bottom cushion base 272, and a second bottom cushion, shown as passenger bottom cushion 274, coupled to the passenger bottom cushion base 272. The passenger bottom cushion base 272 includes a second support surface, shown as passenger base surface 276, on a first side of the passenger bottom cushion base 272. The passenger bottom cushion 274 may be coupled to an opposing second side of the passenger bottom cushion base 272 (e.g., opposing the passenger base surface 276, etc.). When the passenger seat portion 254 is in the passenger seat configuration, the passenger base surface 276 may contact the passenger base storage surface 262 to support the passenger bottom cushion assembly 270 on the passenger seat base 260. When the passenger seat portion 254 is in the passenger storage configuration, the passenger base surface 276 may define a second portion of the storage bed of the vehicle 10. By way of example, when the passenger seat portion 254 is in the passenger storage configuration, the passenger base surface 276 may align with the passenger base storage surface 262 to form the front portion of the storage bed of the vehicle 10.

According to the exemplary embodiment shown in FIG. 5, when the passenger seat portion 254 is in the passenger storage configuration and the rear row seat assembly 200 is in the rear row storage configuration, the passenger base storage surface 262, the passenger base surface 276, the rear base storage surface 212, and the rear row base surface 226 define the storage bed of the vehicle 10. By way of example, when the passenger seat portion 254 is in the passenger storage configuration and the rear row seat assembly 200 is in the rear row storage configuration, the passenger base storage surface 262, the passenger base surface 276, the rear base storage surface 212, and the rear row base surface 226 may align with each other to form the storage bed of the vehicle 10.

As shown in FIGS. 3-5, the passenger back cushion assembly 280 includes a second back cushion, shown as passenger back cushion 282, configured to releasably coupled to at least one of the frame 12 or the body 20. According to the exemplary embodiment shown in FIGS. 3-5, the passenger back cushion 282 is configured to releasably couple the b-pillars 114 of the canopy assembly 110. When the front row seat assembly 250 is in the passenger seat configuration, the passenger back cushion assembly 280 may be releasably coupled to at least one of the b-pillars 114. When the front row seat assembly 250 is in the passenger storage configuration, the passenger back cushion assembly 280 may be detached from the canopy assembly 110 and stowed elsewhere on the vehicle 10 and/or stowed external to the vehicle 10. In other embodiments, the passenger back cushion assembly 280 is configured to releasably couple to the passenger seat base 260 and/or the passenger bottom cushion assembly 270 (e.g., via a component similar to the rear row back cushion frame 232).

As shown in FIG. 5, the passenger bottom cushion base 272 of the passenger bottom cushion assembly 270 is pivotably coupled to a second forward edge of the passenger seat base 260, shown as passenger pivot edge 268. The passenger bottom cushion assembly 270 may pivot about the passenger pivot edge 268 between a passenger seat position to place the passenger seat portion 254 in the passenger seat configuration and a passenger storage position to place the passenger seat portion 254 in the passenger storage configuration. By way of example, the passenger bottom cushion assembly 270 may pivot forward about the passenger pivot edge 268 from the passenger seat position towards the passenger storage position. By way of another example, the passenger bottom cushion assembly 270 may pivot rearward about the passenger pivot edge 268 from the passenger storage position towards the passenger seat position. In other embodiments, the passenger bottom cushion base 272 of the passenger bottom cushion assembly 270 is pivotably coupled to a second rear edge of the passenger seat base 260 and may pivot about the second rear edge of the passenger seat base 260 between the passenger seat position and the passenger storage position. By way of example, the passenger bottom cushion assembly 270 may pivot rearward about the second rear edge of the passenger seat base 260 from the passenger seat position toward the passenger storage position and/or forward about the second rear edge of the passenger seat base 260 from the passenger storage position toward the passenger seat position. In still other embodiments, the passenger seat base 260 otherwise moves (e.g., translates, slides, etc.) relative to the passenger seat base 260 to move between the passenger seat position and the passenger storage position.

As shown in FIG. 5, when the passenger bottom cushion assembly 270 is in the passenger storage position, the passenger bottom cushion assembly 270 and at least one of the frame 12 or the body 20 defines a passenger storage opening 278. By way of example, the passenger storage opening 278 may include a passenger footwell where the passenger of the passenger seat portion 254 may place their feet while occupying the passenger seat portion 254. By way of another example, the passenger storage opening 278 may be positioned between the passenger bottom cushion 274 and the at least one of the frame 12 or the body 20 when the passenger seat portion 254 is in the passenger storage configuration. According to the exemplary embodiment shown in FIG. 5, when the passenger seat portion 254 is in the passenger storage configuration, the passenger back cushion assembly 280 may be positioned within the passenger storage opening 278 such that the passenger back cushion assembly 280 is positioned below the passenger base storage surface 262 and/or the passenger base surface 276. As a result, the passenger back cushion assembly 280 may not be positioned within a passenger storage area positioned above the passenger portion of the storage bed of the vehicle 10 when the passenger seat portion 254 is in the passenger storage configuration.

According to an exemplary embodiment, the passenger back cushion assembly 280 is pivotably coupled to the passenger seat base 260. The passenger back cushion assembly 280 may pivot relative to the passenger seat base 260 to place the passenger seat portion 254 in the passenger storage configuration or the passenger seat configuration. By way of example, when the vehicle 10 includes the back row seating 34 behind the front row seating 32, the passenger back cushion assembly 280 may pivot rearward relative to the passenger seat base 260 into the rear row storage opening 228 of the rear row seat assembly 200 such that the passenger back cushion assembly 280 is positioned below the passenger base storage surface 262 and/or the passenger base surface 276. Once the passenger back cushion assembly 280 is within the rear row storage opening 228, the rear row bottom cushion assembly 220 may pivot into the rear row storage position to cover or extend over the passenger back cushion assembly 280. By way of another example, the passenger back cushion assembly 280 may pivot forward relative to the passenger seat base 260 such that the passenger back cushion assembly 280 extends above the passenger base storage surface 262 and/or the passenger base surface 276 to place the passenger seat portion 254 in the passenger seat configuration.

As shown in FIG. 5, the passenger seat portion 254 includes a second interface assembly, shown as passenger interface assembly 290, configured to secure the passenger bottom cushion assembly 270 in the passenger seat position and/or the passenger storage position. The passenger interface assembly 290 may selectively prevent the passenger bottom cushion assembly 270 from pivoting relative to the passenger seat base 260. By way of example, the passenger interface assembly 290 may be coupled to the passenger bottom cushion assembly 270 and configured to interface with the passenger seat base 260 when the passenger bottom cushion assembly 270 is in the passenger seat position to selectively prevent the passenger bottom cushion assembly 270 from pivoting relative to the passenger seat base 260 such that the passenger seat portion 254 is prevented from leaving the passenger seat configuration. By way of another example, the passenger interface assembly 290 may be coupled to the passenger bottom cushion assembly 270 and configured to interface with the body 20 when the passenger bottom cushion assembly 270 is in the passenger storage position to selectively prevent the passenger bottom cushion assembly 270 from pivoting relative to the passenger seat base 260 such that the front row seat assembly 250 is prevented from leaving the passenger storage configuration. The passenger interface assembly 290 may be configured as a latch assembly configured to interface with a corresponding latch assembly of the passenger seat base 260 and/or the body 20, hook or look fastener portions configured to interface with hook and loop fastener portions of the passenger seat base 260 and/or the body 20, or any other means configured to selectively prevent the passenger bottom cushion assembly 270 from pivoting relative to the passenger seat base 260. In some embodiments, the passenger interface assembly 290 may be operated (e.g., by an occupant of the vehicle 10, etc.) to allow the passenger bottom cushion assembly 270 to pivot relative to the passenger seat base 260.

As shown in FIGS. 6-9, the middle row seating 36 includes a third seat assembly (e.g., third flipping seat assembly, third stowable seat assembly, etc.), shown as middle row seat assembly 300 coupled to at least one of the chassis 12 or the body 20. In some embodiments, the middle row seat assembly 300 is coupled to the canopy assembly 110 (e.g., the b-pillars 114, the c-pillars 118, etc.). According to the exemplary embodiment shown in FIGS. 6-9, the middle row seat assembly 300 is forward facing. In other embodiments, the middle row seat assembly 300 is rearward facing. The middle row seat assembly 300 includes a third base, shown as middle row seat base 310, coupled to at least one of the fame 12 or the body 20; a third bottom cushion assembly, shown as middle row bottom cushion assembly 320, configured to support a bottom (e.g., a buttocks, etc.) of an occupant (e.g., when the occupant is occupying the middle row seat assembly 300, etc.); and a third back cushion assembly, shown as middle row back cushion assembly 330, configured to support a back (e.g., a dorsum, etc.) of the occupant.

The middle row seat assembly 300 is selectively reconfigurable (e.g., movable, adjustable, etc.) between a middle row seat configuration where the middle row seat assembly 300 is configured to support an occupant and a middle row storage configuration where the middle row seat assembly 300 defines a middle portion of the storage bed of the vehicle 10. By way of example, the occupant capacity of the vehicle 10 may be higher when the middle row seat assembly 300 is in the middle row seat configuration than when the middle row seat assembly 300 is in the middle row storage configuration. By way of another example, the storage capacity of the vehicle 10 may be higher when the middle row seat assembly 300 is in the middle row storage configuration than when the middle row seat assembly 300 is in the middle row seat configuration.

As shown in FIGS. 6 and 7, the middle row seat assembly 300 can be placed in the middle row seat configuration with the middle row bottom cushion assembly 320 positioned above the middle row seat base 310 and the middle row back cushion assembly 330 oriented in a substantially vertical orientation relative to the middle row bottom cushion assembly 320. As shown in FIG. 8, the middle row seat assembly 300 can be placed in the middle row storage configuration with an upper surface of the middle row bottom cushion assembly 320 positioned substantially even with an upper surface of the middle row seat base 310 to form the middle portion of the storage bed of the vehicle 10 and the middle row back cushion assembly 330 is positioned below the upper surfaces of the middle row bottom cushion assembly 320 and the middle row seat base 310. In some embodiments, the middle row bottom cushion assembly 320 may rest on the front seating row 32 when the middle row seat assembly 300 is in the middle row storage configuration. In other embodiments, the middle row bottom cushion assembly 320 may rest on at least one of the body 20 or the frame 12 when the middle row seat assembly 300 is in the middle row storage configuration. In some embodiments, a first portion of the middle row seat assembly 300 may be placed in the middle row storage configuration and/or the middle row seat configuration separately (e.g., independently, etc.) from a second portion of the middle row seat assembly 300. By way of example, a left side portion of the middle row seat assembly 300 may be independently operated between the middle row storage configuration and the middle row seat configuration from a right side portion of the middle row seat assembly 300. In some embodiments, the middle row seat assembly 300 are removably coupled to at least one of the frame 12 or the body 20 and may be removed from the vehicle 10 to increase a storage volume of the vehicle 10.

As shown in FIGS. 8 and 9, the middle row seat base 310 includes a third upper surface, shown as middle base storage surface 312, extending at least partially along the middle row seat base 310 and a third upper lip, shown as middle base lip 314, extending around at least a portion of a perimeter of the middle base storage surface 312. The middle base storage surface 312 may support the middle row bottom cushion assembly 320 when the middle row seat assembly 300 is in the middle row seat configuration and define a first portion of the middle portion of the storage bed of the vehicle 10 when the middle row seat assembly 300 is in the middle row storage configuration. By way of example, the middle base storage surface 312 may be a substantially flat surface that may either support the middle row bottom cushion assembly 320 or define the first portion of the middle portion of the storage bed of the vehicle 10. As shown in FIGS. 8 and 9, the middle base lip 314 and the middle base storage surface 312 collectively define a third cavity, shown as middle seat cavity 316. The middle seat cavity 316 may receive at least a portion of the middle row bottom cushion assembly 320 when the middle row seat assembly 300 is in the middle row seat configuration. By way of example, the middle seat cavity 316 may receive the portion of the middle row bottom cushion assembly 320 when the middle row seat assembly 300 is in the middle row seat configuration to prevent lateral movement of the middle row bottom cushion assembly 320 relative to the middle row seat base 310.

As shown in FIGS. 6-9, the middle row bottom cushion assembly 320 includes a third bottom cushion base, shown as middle row bottom cushion base 322, and a third bottom cushion, shown as middle row bottom cushion 324, coupled to the middle row bottom cushion base 322. The middle row bottom cushion base 322 includes a third support surface, shown as middle row base surface 326, on a first side of the middle row bottom cushion base 322. The middle row bottom cushion 324 may be coupled to an opposing second side of the middle row bottom cushion base 322 (e.g., opposing the middle row base surface 326, etc.). When the middle row seat assembly 300 is in the middle row seat configuration, the middle row base surface 326 may contact the middle base storage surface 312 to support the middle row bottom cushion assembly 320 on the middle row seat base 310. When the middle row seat assembly 300 is in the middle row storage configuration, the middle row base surface 326 may define a second portion of the middle portion of the storage bed of the vehicle 10. By way of example, when the middle row seat assembly 300 is in the middle row storage configuration, the middle row base surface 326 may align (e.g., be coincident with, be substantially even with, be oriented at a same angle as, etc.) with the middle base storage surface 312 to form the middle portion of the storage bed of the vehicle 10.

According to the exemplary embodiment shown in FIGS. 8 and 9, when the middle row seat assembly 300 is in the middle row storage configuration and the rear row seat assembly 200 is in the rear row storage configuration, the rear base storage surface 212, the rear row base surface 226, the middle base storage surface 312, and the middle row base surface 326 define the storage bed of the vehicle 10. By way of example, when the middle row seat assembly 300 is in the middle row storage configuration and the rear row seat assembly 200 is in the middle row storage configuration, the rear base storage surface 212, the rear row base surface 226, the middle base storage surface 312, and the middle row base surface 326 may align with each other to form the storage bed of the vehicle 10. In some embodiments, when the rear row seat assembly 200 is in the rear row storage configuration, the front row seat assembly 250 is in the passenger storage configuration, and the middle row seat assembly 300 is in the middle row storage configuration, the rear base storage surface 212, the rear row base surface 226, the passenger base storage surface 262, the passenger base surface 276, the middle base storage surface 312, the middle row base surface 326 define the storage bed of the vehicle 10. By way of example, when the middle row seat assembly 300 is in the middle row storage configuration, the rear row seat assembly 200 is in the middle row storage configuration, and the front row seat assembly 250 is in the passenger storage configuration, the rear base storage surface 212, the rear row base surface 226, the passenger base storage surface 262, the passenger base surface 276, the middle base storage surface 312, the middle row base surface 326 may align with each other to form the storage bed of the vehicle 10.

As shown in FIGS. 6-9, the middle row back cushion assembly 330 includes a third back cushion frame, shown as middle row back cushion frame 332, and a first back cushion, shown as middle row back cushion 334, coupled to the middle row back cushion frame 332. According to the exemplary embodiment shown in FIGS. 6 and 7, the middle row back cushion frame 332 is configured to releasably couple to the middle row seat base 310. By way of example, the middle row back cushion frame 332 may include a plurality of middle row back cushion legs that may be selectively received within apertures defined by the middle row seat base 310 to releasably couple the middle row back cushion assembly 330 to the middle row seat base 310. When the middle row seat assembly 300 is in the middle row seat configuration, the middle row back cushion assembly 330 may be releasably coupled to the middle row seat base 310. When the middle row seat assembly 300 is in the middle row storage configuration, the middle row back cushion assembly 330 may be detached from the middle row seat base 310 and stowed elsewhere on the vehicle 10 and/or stowed external to the vehicle 10. According to the exemplary embodiment shown in FIG. 9, the middle row back cushion frame 332 is configured to releasably couple to at least one of the c-pillars 118 of the canopy assembly 110. When the middle row seat assembly 300 is in the middle row seat configuration, the middle row back cushion frame 332 may be releasably coupled to the c-pillars 118. When the middle row seat assembly 300 is in the middle row storage configuration, the middle row back cushion frame 332 may detached from the canopy assembly 110 and stowed elsewhere on the vehicle 10 and/or stowed external to the vehicle 10. In other embodiments, the middle row back cushion assembly 330 is configured to releasably couple to the middle row bottom cushion assembly 320.

As shown in FIGS. 8 and 9, the middle row bottom cushion base 322 of the middle row bottom cushion assembly 320 is pivotably coupled to a third forward edge of the middle row seat base 310, shown as middle row pivot edge 318. The middle row bottom cushion assembly 320 may pivot about the middle row pivot edge 318 between a middle row seat position to place the middle row seat assembly 300 in the middle row seat configuration and a middle row storage position to place the middle row seat assembly 300 in the middle row storage configuration. By way of example, the middle row bottom cushion assembly 320 may pivot forward about the middle row pivot edge 318 from the middle row seat position towards the middle row storage position. By way of another example, the middle row bottom cushion assembly 320 may pivot rearward about the middle row pivot edge 318 from the middle row storage position toward the middle row seat position. In other embodiments, the middle row bottom cushion base 322 of the middle row bottom cushion assembly 320 is pivotably coupled to a third rear edge of the middle row seat base 310 and may pivot about the third rear edge of the middle row seat base 310 between the middle row seat position and the middle row storage position. By way of example, the middle row bottom cushion assembly 320 may pivot rearward about the third rear edge of the middle row seat base 310 from the middle row seat position toward the middle row storage position and/or forward about the third rear edge of the middle row seat base 310 from the middle row storage position toward the middle row seat position. In still other embodiments, the middle row bottom cushion assembly 320 otherwise moves (e.g., translates, slides, etc.) relative to the middle row seat base 310 to move between the middle row seat position and the middle row storage position (e.g., slide, translate, etc.).

As shown in FIGS. 8 and 9, when the middle row bottom cushion assembly 320 is in the middle row storage position, the middle row bottom cushion assembly 320 and at least one of the frame 12 or the body 20 defines a middle row storage opening 328. By way of example, the middle row storage opening 328 may include a middle row footwell where an occupant of the middle row seat assembly 300 may place their feet while occupying the middle row seat assembly 300. By way of another example, the middle row storage opening 328 may be positioned between the middle row bottom cushion 324 and the at least one of the frame 12 or the body 20 when the middle row seat assembly 300 is in the middle row storage configuration. According to an exemplary embodiment, when the middle row seat assembly 300 is in the middle row storage configuration, the middle row back cushion assembly 330 may be positioned (e.g., stowed, etc.) within the middle row storage opening 328 such that the middle row back cushion assembly 330 is positioned below the middle base storage surface 312 and/or the middle row base surface 326. As a result, the middle row back cushion assembly 330 may not be positioned within a middle storage area positioned above the middle portion of the storage bed of the vehicle 10 when the middle row seat assembly 300 is in the middle row storage configuration.

According to the exemplary embodiment shown in FIG. 8, the middle row back cushion frame 332 of the middle row back cushion assembly 330 is pivotably coupled to the middle row seat base 310. The middle row back cushion assembly 330 may pivot relative to the middle row seat base 310 to place the middle row seat assembly 300 in the middle row storage configuration and/or the middle row seat configuration. By way of example, when the vehicle 10 includes the back row seating 34 behind the middle row seating 36, the middle row back cushion assembly 330 may pivot rearward relative to the middle row seat base 310 into the rear row storage opening 228 of the rear row seat assembly 200 such that the middle row back cushion assembly 330 pivots below the middle base storage surface 312 and/or the middle row base surface 326. Once the middle row back cushion assembly 330 is within the rear row storage opening 228, the rear row bottom cushion assembly 220 may pivot into the rear row storage position to cover or extend over the middle row back cushion assembly 330. By way of another example, the middle row back cushion assembly 330 may pivot forward relative to the middle row seat base 310 such that the middle row back cushion assembly 330 extends above the middle base storage surface 312 and/or the middle row base surface 326 to place the middle row seat assembly 300 in the middle row seat configuration.

As shown in FIGS. 8 and 9, the middle row seat assembly 300 includes a third interface assembly, shown as middle row interface assembly 340, configured to secure the middle row bottom cushion assembly 320 in the middle row seat position and/or the middle row storage position. The middle row interface assembly 340 may selectively prevent the middle row bottom cushion assembly 320 from pivoting relative to the middle row seat base 310. By way of example, the middle row interface assembly 340 may be coupled to the middle row bottom cushion assembly 320 and configured to interface with the middle row seat base 310 when the middle row bottom cushion assembly 320 is in the middle row seat position to selectively prevent the middle row bottom cushion assembly 320 from pivoting relative to the middle row seat base 310 such that the middle row seat assembly 300 is prevented from leaving the middle row seat configuration. By way of another example, the middle row interface assembly 340 may be coupled to the middle row bottom cushion assembly 320 and configured to interface with the front row seating 32 (e.g., the passenger seat base 260, etc.) when the middle row bottom cushion assembly 320 is in the middle row storage position to selectively prevent the middle row bottom cushion assembly 320 from pivoting relative to the middle row seat base 310 such that the middle row seat assembly 300 is prevented from leaving the middle row storage configuration. The middle row interface assembly 340 may be configured as a latch assembly configured to interface with a corresponding latch assembly of the middle row seat base 310 and/or the front row seating 32, hook or look fastener portions configured to interface with hook and loop fastener portions of the middle row seat base 310 and/or the front row seating 32, or any other means configured to selectively prevent the middle row bottom cushion assembly 320 from pivoting relative to the middle row seat base 310. In some embodiments, the middle row interface assembly 340 may be operated (e.g., by an occupant of the vehicle 10, etc.) to allow the middle row bottom cushion assembly 320 to pivot relative to the middle row seat base 310.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, the rear row seat assembly 200, the front row seat assembly 250, the middle row seat assembly 300, etc.) as shown in the various exemplary embodiments is illustrative only. Additionally, any element disclosed in one embodiment may be incorporated or utilized with any other embodiment disclosed herein.

1. A golf vehicle comprising:
a chassis;
a body coupled to the chassis; and
a seat assembly movable between a seat configuration and a storage configuration, the seat assembly including:
a seat base coupled to at least one of the chassis or the body; and
a bottom cushion assembly movably coupled to the seat base, wherein the bottom cushion assembly is in a first position above the seat base when the seat assembly is in the seat configuration and is in a second position forward of the seat base when the seat assembly is in the storage configuration.

2. The golf vehicle of claim 1, wherein:
the seat base defines a first surface;
the bottom cushion assembly defines a second surface; and
the second surface aligns with the first surface when the bottom cushion assembly is in the second position to define at least a portion of a storage bed of the golf vehicle.

3. The golf vehicle of claim 2, wherein the second surface is supported by the first surface when the bottom cushion assembly is in the first position.

4. The golf vehicle of claim 2, wherein:
the second surface is on a first side of the bottom cushion assembly; and
the bottom cushion assembly includes a bottom cushion on an opposing second side of the bottom cushion assembly.

5. The golf vehicle of claim 1, wherein:
the body and the bottom cushion assembly collectively define a storage opening when the bottom cushion assembly is in the second position; and
the seat assembly includes a back cushion assembly removably coupled to the seat base, the back cushion assembly configured to be received by the storage opening when the seat assembly is in the storage configuration.

6. The golf vehicle of claim 1, further comprising:
a canopy assembly including:
a plurality of pillars; and
a canopy coupled to the pillars, the canopy covering at least a portion of the seat assembly; and
the seat assembly includes a back cushion assembly removably coupled to at least one of the plurality of pillars.

7. The golf vehicle of claim 1, wherein the seat assembly includes:
a back cushion assembly pivotably coupled to the seat base, wherein the back cushion assembly is in a third position above the seat base when the seat assembly is in the seat configuration and is in a fourth position rearward of the seat base when the seat assembly is in the storage configuration.

8. The golf vehicle of claim 1, further comprising a front row seat assembly positioned forward of the seat assembly, wherein the bottom cushion assembly is supported by the front row seat assembly when the bottom cushion assembly is in the second position.

9. The golf vehicle of claim 8, wherein the bottom cushion assembly includes an interface assembly configured to releasably couple to the front row seat assembly when the bottom cushion assembly is in the second position.

10. The golf vehicle of claim 1, wherein a first portion of the bottom cushion assembly and a second portion of the bottom cushion assembly are separately movable between the first position and the second position.

11. The golf vehicle of claim 1, wherein the bottom cushion assembly pivots forward relative to the seat base to move the bottom cushion assembly from the first position to the second position.

12. The golf vehicle of claim 1, further comprising a forward seat assembly coupled to at least one of the chassis or the body, the forward seat assembly positioned forward of the seat assembly, the forward seat assembly movable between a forward seat configuration and a forward storage configuration where the forward seat assembly defines a forward portion of the storage bed.

13. A recreational vehicle comprising:
a chassis;
a body coupled to the chassis;
a first seat assembly coupled to at least one of the chassis or the body, the first seat assembly movable between a first seat configuration and a first storage configuration where the first seat assembly defines a first portion of a storage bed of the recreational vehicle; and
a second seat assembly coupled to at least one of the chassis or the body, the second seat assembly positioned forward of the first seat assembly, the second seat assembly movable between a second seat configuration and a second storage configuration where the second seat assembly defines a second portion of the storage bed.

14. The recreational vehicle of claim 13, wherein a portion of the first seat assembly is supported by the second seat assembly when the first seat assembly is in the first storage configuration.

15. The recreational vehicle of claim 13, wherein the first seat assembly includes an interface assembly configured to releasably couple to the second seat assembly when the first seat assembly is in the first storage configuration.

16. The recreational vehicle of claim 13, wherein:
the second seat assembly is a front seat assembly including a driver seat portion and a passenger seat portion; and
the passenger seat portion includes:
a passenger seat base coupled to the at least one of the chassis or the body; and
a passenger bottom cushion assembly movably coupled to the passenger seat base, wherein the passenger bottom cushion assembly is in a first position above the passenger seat base when the second seat assembly is in the second seat configuration and is in a second position forward of the passenger seat base when the second seat assembly is in the second storage configuration.

17. The recreational vehicle of claim 13, further comprising a third seat assembly coupled to at least one of the chassis or the body, the second seat assembly positioned forward of the first seat assembly and rearward of the second seat assembly, the third seat assembly movable between a third seat configuration and a third storage configuration where the third seat assembly defines a third portion of the storage bed.

18. The recreational vehicle of claim, 17 further comprising a canopy assembly including:
a plurality of first pillars;
a plurality of second pillars positioned rearward of the first pillars;
a plurality of third pillars positioned rearward of the second pillars; and
a canopy coupled to the first pillars, the second pillars, and the third pillars, the canopy covering at least one of the first seat assembly, the second seat assembly, or the third seat assembly;
wherein the third seat assembly is coupled to at least one of the second pillars.

19. A forward-facing seat assembly for a recreational vehicle, the seat assembly comprising:
a seat base configured to couple to at least one of a chassis or a body of the recreational vehicle, the seat base defining a first surface;
a bottom cushion assembly pivotably coupled to the seat base, the bottom cushion assembly defining a second surface on a first side of the bottom cushion assembly, the bottom cushion assembly pivotable between a first position where the second surface is supported by the first surface and a second position where the second surface aligns with the first surface; and
a back cushion assembly at least one of removably or pivotably coupled to the seat base, wherein the back cushion assembly is in a third position above the seat base when the seat assembly is in the third configuration and is in a fourth position below the first surface of the seat base when the seat assembly is in the storage configuration.

20. The seat assembly of claim 19, wherein a first portion of the bottom cushion assembly and a second portion of the bottom cushion assembly are separately pivotably between the first position and the second position.
